(19) United States
(12) Patent Application Publication
(10) Pub. No.: US 2005/0235100 A1
(43) Pub. Date: Oct. 20, 2005

(54) Semiconductor integrated circuit device, microcomputer, and electronic equipment

(76) Inventor: Mikio Sakurai, Ibaraki (JP)

Correspondence Address: HARNESS, DICKEY & PIERCE, P.L.C., P.O. BOX 828, BLOOMFIELD HILLS, MI, 48303, US

(21) Appl. No.: 11/099,286

(22) Filed: Apr. 5, 2005

(30) Foreign Application Priority Data
Apr. 20, 2004 (JP) 2004-124387

(51) Int. Cl. G06F 12/00

(52) U.S. Cl. 711/106

(57) ABSTRACT

A semiconductor integrated circuit device includes a memory controller which performs access control based on an access request from the host with respect to a dynamic random access memory having a self-refresh function. The memory controller includes a counter which counts a specified period after detecting an idle state, as well as a state machine and a control signal generating circuit which, after the counter counts the idle state period, performs processing necessary to instruct the dynamic random access memory to shift to a self-refresh state.

### RELATED APPLICATIONS

This application claims priority to Japanese Patent Application No. 2004-124387 filed Apr. 20, 2004 which is hereby expressly incorporated by reference herein in its entirety.

### BACKGROUND

1. Technical Field

The present invention relates to a semiconductor integrated circuit device, a microcomputer, and electronic equipment.

2. Related Art

Upon completion of a read/write operation to an SDRAM, a memory controller returns to an idle state.

To put the SDRAM into a self-refresh state again, it was conventionally necessary for a program (host) to re-issue a command for setting a self-refresh setting bit of the SDRAM. Consequently, on the program (host) side, it was necessary to control resetting of the self-refresh upon completion of the read/write operation to the SDRAM.

In a state of no access from the host, it becomes possible to reduce power consumption of the SDRAM in the self-refresh state.

Hence, how efficiently the reduction of power consumption of the system should be attained becomes a problem without awareness on the part of the program.

The present invention has been made in view of the above-mentioned problem. It is an object thereof to provide a semiconductor integrated circuit device, a microcomputer, and electronic equipment which can reduce the power consumption of the system efficiently without awareness on the part of the program.

### SUMMARY

The present invention is a semiconductor integrated circuit device including a memory controller performing access control based on an access request from a host with respect to a dynamic random access control having a self-refresh function, the memory controller comprising: a counter counting a specified period after detecting an idle state; and a self-refresh shift instructing circuit which performs processing necessary for the counter, after counting the period, to instruct the dynamic random access memory to shift to a self-refresh state.

The dynamic random access memory includes a DRAM and a synchronous DRAM (hereinafter referred to as SDRAM).

The SDRAM is a DRAM characterized by performing a read/write operation synchronously with the clock. The read/write operation in the DRAM and the SDRAM is carried out by inputting a command.

For the DRAM and the SDRAM, there are main states such as the idle state of waiting for a command input from the host, a memory read/write state including a read state of outputting to the host any data subsequent to an input address with the command and the address being inputted, and a memory read/write state such as a write state of writing data inputted in the input address thereafter, the self-refresh state (in this state, a clock signal to be supplied to the SDRAM is stopped to reduce power consumption) in which refreshing memory data is automatically executed in side the DRAM and the SDAM, an auto refresh state to execute refresh according to a request from the host, and the like.

The self-refresh shift instruction given by the self-refresh shift instructing circuit may be configured such that, for example, a self-refresh shift instruction signal (including a command) is generated to output to a dynamic random access memory. Further, for example, if the configuration is such that self-refresh is carried out in a case where a self-refresh setting bit is set in the dynamic random access memory, the configuration may be such as to issue a command setting the self-refresh setting bit.

According to the present invention, since it is possible to instruct a shift to the self-refresh state without going through the host, power saving may be realized even though the host side is not aware of it.

Further, if a shift is made to the self-refresh state upon being in the idle state, then, should there be followed an access request, it is necessary to pull out of the self-refresh state again, so that overhead generates. In the present invention, however, after a lapse of a specified time subsequent to detecting the idle, a shift is made to the self-refresh state, hence, overhead when access is followed can be prevented.

The semiconductor integrated circuit device of the present invention is characterized in that a specified period is a shorter interval than an auto-refresh request interval.

At this point, the memory controller may be configured such as to include an auto-refresh instructing circuit which carries out processing to instruct an applicable memory to perform auto-refresh at an appropriate interval with respect to the dynamic access memory, and the self-refresh shift instructing circuit may be configured such that the counter, after detecting the idle state, instructs the dynamic random access memory to shift to the self-refresh state.

For example, it may be realized by configuring such that the counter may count a specified period which is at a shorter interval than the auto-refresh request interval.

According to the present invention, it is possible to make a shift to self-refresh mode at a shorter interval than an interval for performing the auto-refresh request after the idle state is attained. Consequently, when the idle period is detected, a shift to the self-refresh state may be made more constantly, so that power saving may be carried out more efficiently.

The present invention is a semiconductor integrated circuit device including a memory controller performing access control based on the access request from the host with respect to the dynamic random access control having the self-refresh function, the memory controller comprising: the self-refresh shift instructing circuit which performs, after detecting the idle state, processing necessary for instructing the dynamic random access memory to shift to the self-refresh state.

According to the present invention, since it is possible to instruct a shift to the self-refresh state without going through the host, power saving may be realized even though the host side is not aware of it.

The semiconductor integrated circuit device of the present invention has the memory controller further comprising: the self-refresh release instructing circuit giving self-refresh release instruction, upon receiving the access request from the host, necessary for instructing the dynamic random access memory to release the self-refresh state; and an access request circuit generating and outputting an access request signal, after instructing to release self-refresh.

Self-refresh release instruction carried out by the self-refresh release instructing circuit may be configured, for example, such that a self-refresh release instruction signal is generated and outputted to the dynamic random access memory. Further, for example, if configuration is such that self-refresh is carried out in a case where the self-refresh setting bit is set with respect to the dynamic random access memory, it may be configured such as to issue a command to release the setting of the self-refresh setting bit.

According to the present invention, when an access request generates, a self-refresh release instruction is automatically given by the memory controller side, so that the host or a control program executed by the host may make an access request without controlling whether the dynamic random access memory is in the self-refresh state or not.

As a result, it is made possible to prevent a data access delay caused by making the control program operate for releasing the self-refresh state at the time of making the access request.

The semiconductor integrated circuit device of the present invention has the memory controller further comprising: a self-refresh resetting register capable of setting a selected value as to whether to reset the self-refresh or not; and a self-refresh shift instructing circuit referring to the self-refresh resetting register, and if a set value permitting resetting of the self-refresh is not stored therein, the self-refresh shift instruction is not given.

Resetting of the self-refresh means to carry out resetting of the self-refresh again upon access completion, when the self-refresh is automatically released according to the access request.

For example, when making a substantial access to the dynamic random access memory after the idle state is produced, should resetting of self-refresh be carried out, overhead may generate due to the continuous access, therefore, it is desirable to be able to select whether the resetting of the self-refresh is carried out or not.

According to the present invention, if a set value to permit execution of the self-refresh is not stored in the self-refresh resetting register, the self-refresh shift instruction is not given, hence, it is possible to prevent generation of overhead in such a case.

The present invention is a microcomputer comprising a semiconductor integrated circuit device described in any of the above.

The present invention is electronic equipment comprising the microcomputer described above, input means of data subject to processing by the microcomputer, and LCD output means outputting data processed by the microcomputer.

### BRIEF DESCRIPTION OF THE DRAWINGS

FIG. 1 is a diagram to explain a semiconductor integrated circuit device of the present embodiment;

FIG. 2 is a diagram to explain realization of automatic release from self-refresh;

FIG. 3 is a diagram to explain realization of resetting of the self-refresh;

FIG. 4 is a diagram to explain realization of resetting of the self-refresh after a specified cycle subsequent to detection of an idle state;

FIG. 5 is a diagram relationship between a self-refresh resetting register and setting information on the self-refresh setting register and, and control contents of the memory controller;

FIG. 6 is an example of a hardware block diagram of a microcomputer of the present embodiment;

FIG. 7 is an example of a block diagram of electronic equipment of the present embodiment; and

FIG. 8 A, B, and C are examples of external views of various electronic equipment.

### DETAILED DESCRIPTION

Semiconductor Integrated Circuit Device and Memory Controller

Preferred embodiment of the present invention will be described below with reference to the drawings.

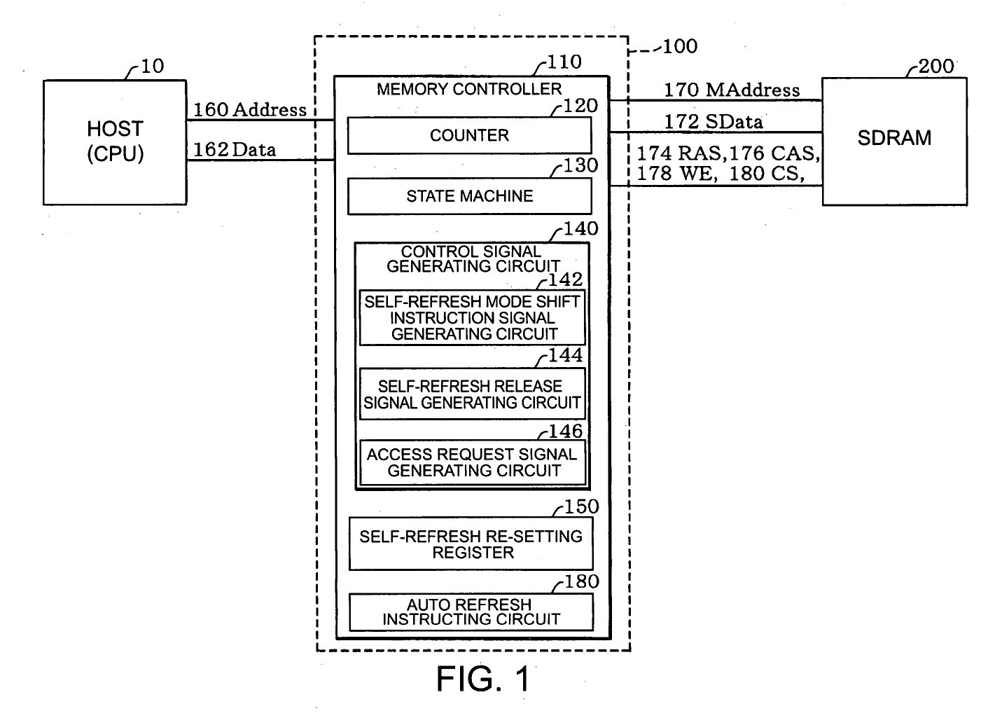

FIG. 1 is a diagram to explain a semiconductor integrated circuit device of the present embodiment.

A semiconductor integrated circuit device 100 according to the present embodiment comprises a memory controller 110 outputting access control signals 170, 172, 174, 176, and 178 to an SDRAM 200 having a self-refresh function, based on access requests 160 and 162 from a host (CPU and DMA).

The memory controller 110 connected to the host (CPU and DMA) 10 and an SDRAM 200 comprises a counter 120, a state machine 130, a control signal generating circuit 140, a self-refresh setting register 150, and an auto refresh instructing circuit 180.

The counter 120, after detecting an idle state, counts a specified cycle. The state machine 130 is hardware that makes a transition of state according to an access request from the host and a state of the SDRAM 200 with an operation of returning from a self-refresh state to the idle state and an operation of making a transition from the idel state to the self-refresh state built in.

The control signal generating circuit generates and outputs the access control signals 170, 172, 174, 176, and 178 with respect to the SDRAM 200, based on the access requests 160 and 162 from the host (CPU and DMA) 10 and a transition of state of the state machine 130.

The control signal (or control command) generating circuit 140 comprises a self-refresh shift instruction signal generating circuit 142, a self-refresh release instruction signal generating circuit 144, and an access request signal generating circuit 146.

After the counter 120 counts the specified cycle, the self-refresh shift instruction signal generating circuit 142 generates and outputs to the dynamic random access memory a self-refresh mode shift instruction signal (including a command) which instructs the SDRAM 200 to shift to self-refresh mode. Further, for example, if it is configured such that self-refresh is carried out when a self-refresh setting bit is set in the dynamic random access memory, it may be configured such that a command to set the self-refresh setting bit is issued.

At this point, the specified cycle (period) may be configured to be a shorter interval than an auto refresh request interval of the host.

After detecting the idle state, the self-refresh shift instruction signal generating circuit 142 may be designed such as to generate and output a self-refresh mode shift instruction signal which instructs the SDRAM 200 to shift to self-refresh mode.

The self-refresh release instruction signal generating circuit 144, when an access request is received from the host 10, may generate and output a self-refresh release signal which instructs the SDRAM 200 to release the self-refresh state.

After the self-refresh release signal is outputted, the access request signal generating circuit 146 generates and outputs an access request signal.

A self-refresh resetting register 150 is a register capable of setting a selected value of whether to reset self-refresh or not from an external input.

The self-refresh shift instruction signal generating circuit 142 refers to the self-refresh resetting register 150, and if a set value permitting resetting of the self-refresh is not stored therein, it may be configured such that the self-refresh mode shift instruction signal is not outputted.

The state machine 130 and the control signal generating circuit 140, after the counter counts the period, function as the self-refresh shift instructing circuit performing processing necessary to instruct the dynamic random access memory to shift to the self-refresh state.

The state machine 130 and the control signal generating circuit 140, upon receiving an access request from the host, function as the self-refresh release instructing circuit performing processing necessary to instruct the dynamic random access memory to release the self-refresh state.

The auto refresh instructing circuit 180 generates an auto refresh request with a counter and the like per fixed period (appropriate interval for a memory used) and performs processing to instruct auto refresh to the SDRAM 200.

The SDRAM 2000 has, for example, a multiplicity of memory cells arranged in row and column directions with the memory cells provided at intersections of row direction lines and column direction lines. At this point, the row direction line is a word line which is selected by an above-mentioned RAS (Row Address Strobe) 174. Further, the column direction line is a data line which is specified by a CAS (Column Address Strobe) 176. Further, a write signal (WE signal) 178 is an instruction signal when writing data (SDATA) 172, which is outputted from the memory controller 110, in the SDRAM 200, and data is written in an address selected by the above-mentioned RAS (Row Address Strobe) 174 and CAS (Column Address Strobe) 176. It should be noted that the SDRAM 200 is constituted by, for example, a plurality of memories, and the memory is selected by a chip select signal (CS signal) 180.

The memory controller 110 creates the above-mentioned RAS (Row Address Strobe) 174 and CAS (Column Address Strobe) 176 according to an address signal 160 supplied from the host (CPU and DMA). Further, the memory controller 110 writes data 162 outputted from the host (CPU and DMA) 10 in an address specified by the above-mentioned RAS/CAS.

For example, when a read access request is outputted from the host (CPU and DMA), the memory controller 110 prepares for data read processing according to the address signal 160. And from the memory controller 110, the RAS (Row Address Strobe) 174 is outputted synchronously with the chip select signal (CS signal) 176 (with the CAS (Column Address Strobe 170) being active). Next, the CAS (Column Address Strobe) is outputted and data is read from an address corresponding to the SDRAM 200. Thereafter, the RAS (Row Address Strobe) 174 and the write signal (WE signal) 178 are outputted and pre-charge processing is performed.

Further, when a write access request is outputted from the host (CPU and DMA), in the same way as above, the memory controller 110 prepares for data write processing (write processing), the RAS (Row Address Strobe) 174 is outputted synchronously with the chip select signal (CS signal) 176 (with the RAS (Row Address Strobe) being active). Next, the CAS (Column Address Strobe) 176 and the write signal (WE signal) 178 are outputted, and data is read from an address corresponding to the SDRAM 200. Thereafter, in the same way as above, the RAS (Row Address Strobe) and the write signal (WE signal 178) are outputted and pre-charge processing is performed.

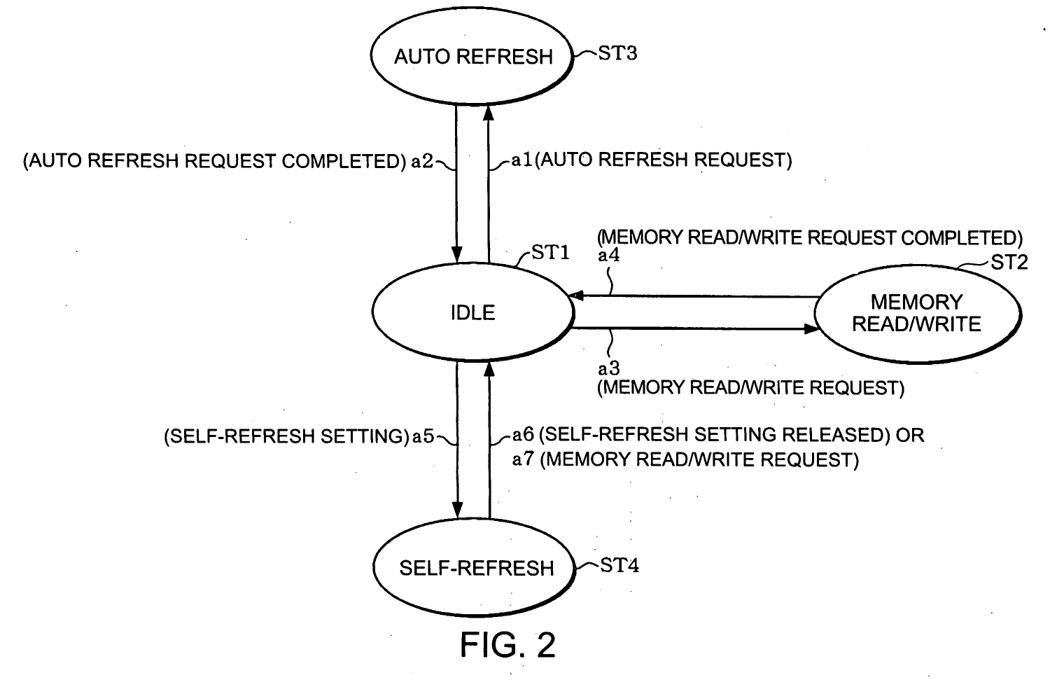

FIG. 2 is a diagram to explain realization of automatic release from the self-refresh.

After the memory control initializes the SDRAM, the SDRAM assumes any of four states of the idle state, the auto refresh state, the self-refresh state, and the read/write state.

In the present embodiment, the state machine of the memory controller memorizes the above-mentioned states of the SDRAM as four states of idle (ST1), auto refresh (ST3), self-refresh (ST4), and memory read/write (ST2).

If a read/write request to the SDRAM occurs when the SDRAM is in the self-refresh state, it was conventionally necessary for the host (program) to issue a command once for returning the state of the state machine of the memory controller to the idle, then, to issue a read/write command.

In the present command, by letting the memory controller automatically perform work to return the self-refresh state (ST4) to the idle state, only upon receiving the read/write command from the host, an automatic release of the self-refresh state of the SDRAM and the subsequent read/write are realized.

If the state of the state machine is the idle (ST1), when an auto refresh request (a1) occurs, an auto refresh request is made to the SDRAM, and the state of the state machine makes a transition to the auto refresh (ST3).

And when completion (a2) of the auto refresh request of the SDRAM is detected, the state of the state machine makes a transition to the idle (ST1).

If the state of the state machine is the idle (ST1), when a memory read/write request (a3) from the CPU occurs, a read/write request is made to the SDRAM, and the state of the state machine makes a transition to the memory read/write (ST2).

And when completion (a4) of the memory read/write request is detected, the state of the state machine makes a transition to the idle (ST1).

If the state of the state machine is the idle (ST1), when a self-refresh setting request (a5) from the CPU occurs, a self-refresh setting request (for example, issuing a command for setting a self-refresh setting bit) is made to the SDRAM, and the state of the state machine makes a transition to the self-refresh (ST4).

At this point, when a release (a6) of the self-refresh setting is received from the CPU, a release request of the self-refresh setting is made to the SDRAM, and the state of the state machine makes a transition to the idle (ST1).

Further, upon receiving a read/write request (a7) from the CPU, a release request of self-refresh setting is made to the SDRAM to drive the state of the state machine to make a transition to the idle (ST1). Thereafter, a read/write request is made to the SDRAM, and the state of the state machine makes a transition to the memory read/write (ST2).

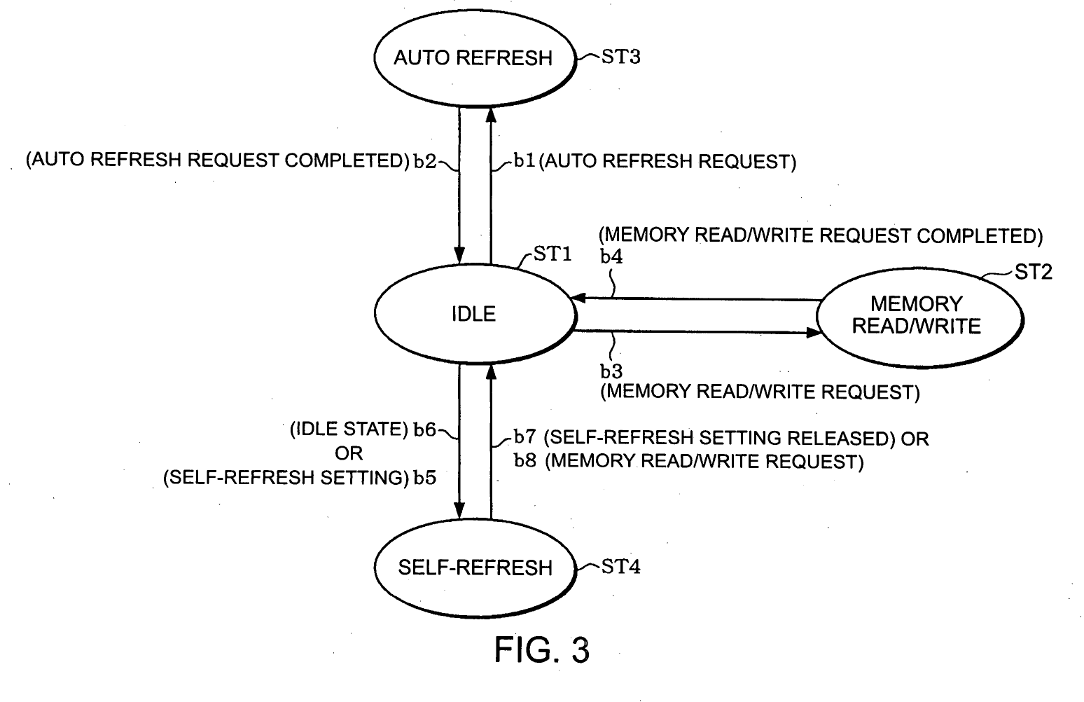

FIG. 3 is a diagram to explain the realization of resetting to self-refresh.

Resetting to the self-refresh means that when the self-refresh is automatically released according to the access request, resetting of the self-refresh is carried out again upon completion of the access.

When a read/write to the SDRAM is completed, the state machine of the memory controller returns to the idle state. To set the SDRAM again in the self-refresh state, it was conventionally necessary for the host (program) to re-issue a command to set the self-refresh setting bit.

However, in the present embodiment, when the idle state is reached after accessing the read/write by letting the memory controller to perform work automatically to make a transition from the idle state to the self-refresh state, automatic setting of the self-refresh is realized.

If the state of the state machine is the idle (ST1), when an auto refresh request (b1) occurs, auto refresh request is made to the SDRAM, and the state of the state machine makes a transition to the auto refresh (ST3).

And when completion (b2) of the read/write request of the SDRAM is detected, the state of the state machine makes a transition to the idle (ST1).

If the state of the state machine is the idle (ST1), when a read/write request (b3) of memory from the CPU occurs, the read/write request is made to the SDRAM, and the state of the state machine makes a transition to the memory read/write (ST2).

And when completion (b4) of the read/write request of the memory is detected, the state of the state machine makes a transition to the idle (ST1).

Thereafter, a self-refresh setting request to the SDRAM (for example, issuing a command to set the self-refresh setting bit) is automatically made, and the state of the state machine makes a transition to the self-refresh (ST4).

If the state of the state machine is the idle (ST1), when a self-refresh request (b5) from the CPU occurs, a self-refresh setting request to the SDRAM (for example, issuing a command to set the self-refresh setting bit) is made, and the state of the state machine makes a transition to the self-refresh (ST4).

At this instant, if a release (b7) of the self-refresh setting is received from the CPU, a release request of the self-refresh setting is made to the SDRAM, and the state of the state machine makes a transition to the idle (ST1).

Further, upon receipt of a read/write request (b8) of memory from the CPU, a release request of the self-refresh setting is made to the SDRAM, and the state of the state machine is made to make a transition to the idle (ST1).

Thereafter, a read/write request to the SDRAM is made, and the state of the state machine makes a transition to the memory read/write (ST2).

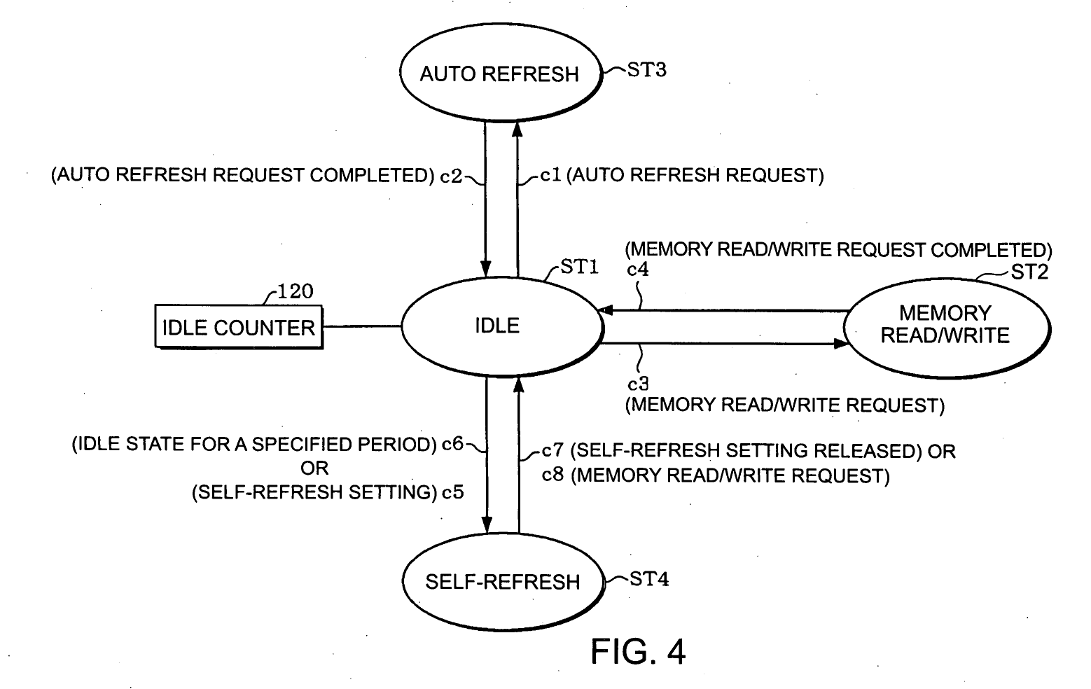

FIG. 4 is a diagram to explain the realization of resetting the self-refresh again following a specified cycle after detecting the idle state.

When the read/write to the SDRAM is completed, the machine of the memory controller returns to the idle state. If the self-refresh state is entered immediately after returning to the idle state upon completion of the read/write to the SDRAM, there may occur a case where a read/write immediately occurs next to make it necessary to pull out of the self-refresh state again.

In the present embodiment, to avoid such overhead, there is provided a counter that activates upon detecting an idle state, so that resetting of the self-refresh state is realized only in case of an idle during a specified period.

If the state of the state machine is the idle (ST1), when an auto refresh request (c1) occurs, an auto refresh setting request to the SDRAM is made, and the state of the state machine makes a transition to the auto refresh (ST3).

And when completion (c2) of the auto refresh request of the SDRAM is detected, the state of the state machine makes a transition to-the idle (ST1).

If the state of the state machine is the idle (ST1), when a read/write request (b3) of memory from the CPU occurs, the read/write request is made to the SDRAM, and the state of the state machine makes a transition to the memory read/write (ST2).

And when completion (c4) of the read/write request of the memory is detected, the state of the state machine makes a transition to the idle (ST1).

Thereafter, when the idle counter 120 detects the idle state continuing for a specified period (c6), a self-refresh setting request to the SDRAM (for example, issuing a command to set the self-refresh setting bit) is made, and the state of the state machine makes a transition to the self-refresh (ST4).

If the state of the state machine is the idle (ST1), when a self-refresh request (c5) from the CPU occurs, the self-refresh setting request to the SDRAM (for example, issuing a command to set the self-refresh setting bit) is made, and the state of the state machine makes a transition to the self-refresh (ST4).

At this instant, if a release (c7) of the self-refresh setting is received from the CPU, a release request of the self-refresh setting is made to the SDRAM, and the state of the state machine makes a transition to the idle (ST1).

Further, upon receipt of a read/write request (c8) of memory from the CPU, a release request of the self-refresh setting is made to the SDRAM, and the state of the state machine is caused to make a transition to the idle (ST1). Thereafter, the read/write request to the SDRAM is made, and the state of the state machine makes a transition to the memory read/write (ST2).

For example, a self-refresh setting register 210 and a self-refresh resetting register 220 may be set up in the memory controller so as to make it possible to set from the outside whether automatic control of the setting and resetting of the self-refresh is to be performed or not, so that the memory controller controls the self-refresh setting and resetting by referring to the self-refresh setting register 210 and the self-refresh resetting register 220.

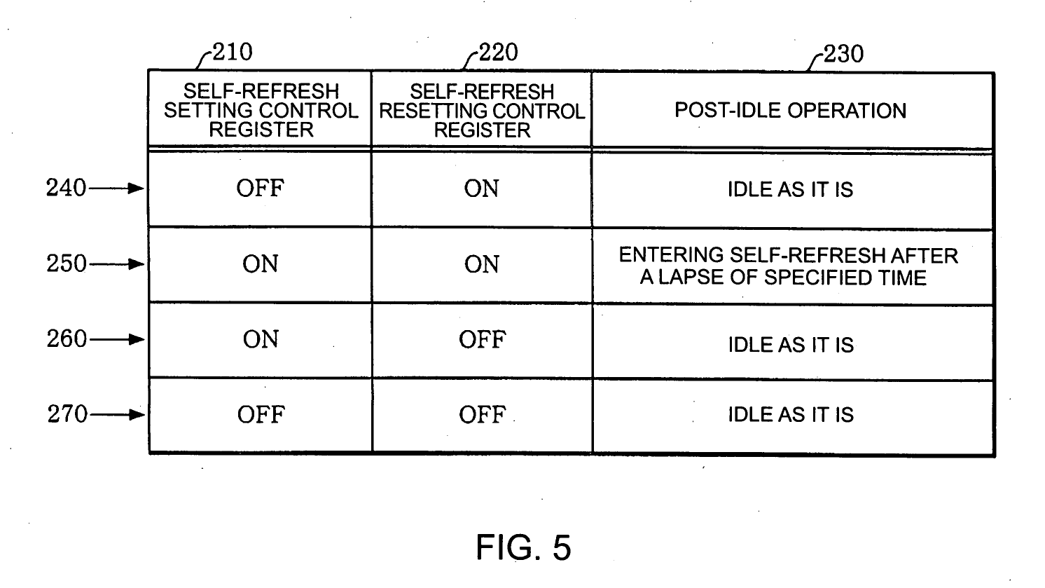

FIG. 5 is a diagram to explain a relationship between setting information on the self-refresh setting register 210 and the self-refresh resetting register 220, and control contents of the memory controller.

The self-refresh setting register 210 is a register for setting whether the memory controller automatically (when carrying out despite no self-refresh request from the host) carries out self-refresh setting control or not: if it is ON, it shows that the memory controller automatically carries out refresh setting control; and if it is OFF, it shows that the memory controller will not automatically carry out refresh setting control.

Further, the self-refresh resetting register 220 is a register for setting whether the memory controller automatically (when carrying out despite no self-refresh request from the host) carries out self-refresh resetting control (control to carry out self-refresh resetting again after access completion when automatically releasing self-refresh according to the access request) or not: if it is ON, it shows that the memory controller automatically carries out refresh resetting control; and if it is OFF, it shows that the memory controller will not automatically carry out self-refresh resetting control.

In a first case 240 (the self-refresh setting control register OFF and the self-refresh resetting control register ON), the idle stays as it is after access completion.

In a second case 250 (the self-refresh setting control register ON and the self-refresh resetting control register ON), the self-refresh is entered after a lapse of specified time subsequent to access completion.

In a third case 260 (the self-refresh setting control register ON and the self-refresh resetting control register OFF), the idle stays as it is after access completion.

In a fourth case 270 (the self-refresh setting control register OFF and the self-refresh resetting control register OFF), the idle stays as it is after access completion.

Microcomputer

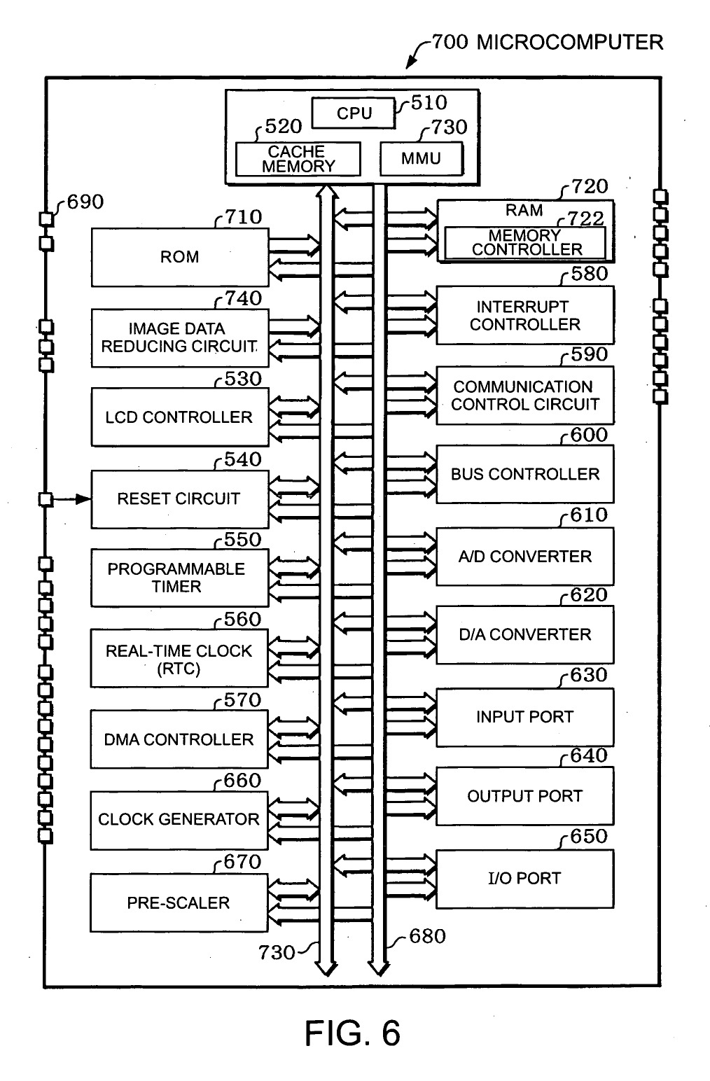

FIG. 6 is an example of a hardware block diagram of a microcomputer according to the present embodiment.

The present microcomputer 700 comprises a CPU 510, a cache memory 520, an LCD controller 530, a reset circuit 540, a programmable timer 550, a real-time clock (RTC) 560, a DRAM controller-cum-bus I/F 570, an interrupt controller 580, a serial interface 590, a bus controller 600, an A/D converter 610, a D/A converter 620, an input port 630, an output port 640, an I/O port 650, a clock generator 560, a pre-scaler 570, an MMU 730, an image processing circuit 740, and a general-purpose bus 680, an exclusive bus 730 and the like connecting these, and various pins 690 and the like.

A RAM 720 includes a dynamic random access memory (DRAM/SDRAM) having a self-refresh function and a memory controller 722 of the present invention.

The memory controller 722 has a configuration explained in FIG. 1.

Electronic Equipment

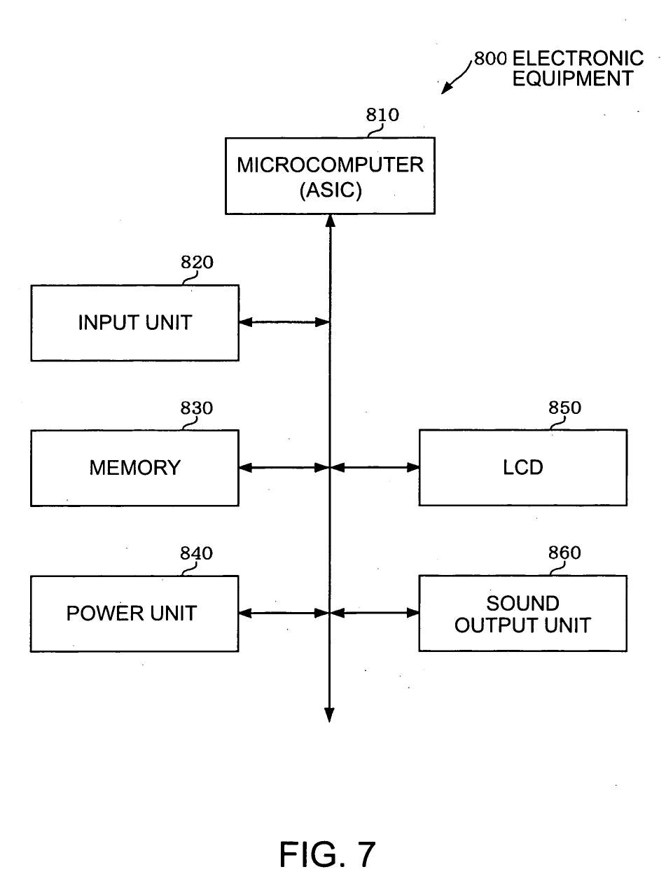

FIG. 7 shows an example of a block diagram of electronic equipment according to the present embodiment. The present electronic equipment 800 consists of a microcomputer (or ASIC) 810, an input unit 820, a memory 830, a power unit 840, an LCD 850, and a sound output unit 860.

At this point, the input unit 820 is for inputting various data. The microcomputer 810 performs various processing based on data inputted by this input unit 820. The memory 840 will be a work area of the microcomputer 810 and the like. The power unit 840 is for generating various power sources to be used by the electronic equipment 800. The LCD 850 is for outputting various images (characters, icons, graphics, and the like) which the electronic equipment displays.

The sound output unit 860 is for outputting various sounds (voice, game sounds, and the like) outputted by the electronic equipment 800 and its function is realized by hardware such as a speaker.

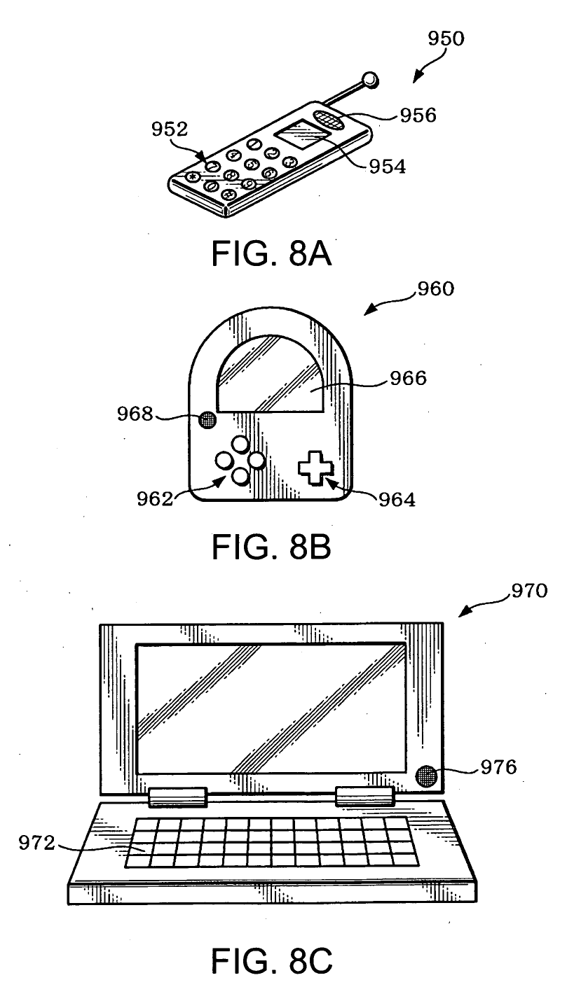

In FIG. 8A, there is shown an example of an external view of a mobile phone 950 which is one of the electronic equipment. This mobile phone 950 is equipped with dial buttons 952, an LCD 954 which displays telephone numbers, names, icons, and the like, and a speaker 956 which functions as the sound output unit and outputs voice.

In FIG. 8B, there is shown an example of an external view of a portable game machine 960 which is one of the electronic equipment. This portable game machine 960 includes operating buttons 962 which function as an input unit, a cross key 964, an LCD 966 displaying game pictures, and a speaker which functions as a sound output unit and outputs game sounds.

In FIG. 8C, there is shown an example of an external view of a personal computer 970 which is one of the electronic equipment. This personal computer 970 includes a keyboard 972 functioning as an input unit, an LCD 974 displaying characters, numerals, graphics, and the like, and a sound output unit 976.

By incorporating a microcomputer of the present embodiment in the electronic equipment of FIG. 8A-FIG. 8C, it is possible to provide electronic equipment with low memory capacity at low cost.

It should be noted that as the electronic equipment which can use the present embodiment, in addition to those which are shown in FIG. A, B, and C, there may be considered various electronic equipment using LCDs such as portable information terminals, pagers, desktop electronic calculators, devices equipped with a touch panel, projectors, word processors, video tape recorders of a view finder type or a monitor type, car navigation systems, and the like.

It should be noted that the present invention is not limited to the present embodiment and that various modifications may-be made within the scope of the spirit of the present invention.

1. A semiconductor integrated circuit device including a memory controller performing access control based on an access request from a host with respect to a dynamic random access control having a self-refresh function, the memory controller comprising:
a counter counting a specified period after detecting an idle state; and
a self-refresh shift instructing circuit which performs processing necessary for the counter, after counting the period, to instruct the dynamic random access memory to shift to a self-refresh state.

2. The semiconductor integrated circuit device according to claim 1, wherein:
the specified period is an interval shorter than an auto refresh request interval.

3. The semiconductor integrated circuit device according to claim 1, the memory controller further comprising:
the self-refresh release instructing circuit giving self-refresh release instruction necessary for instructing the dynamic random access memory to release the self-refresh state, upon receiving the access request from the host; and
an access request circuit generating and outputting an access request signal, after instructing to release the self-refresh.

4. The semiconductor integrated circuit device according to claim 1, the memory controller further comprising:
a self-refresh resetting register capable of setting a selected value as to whether to reset the self-refresh or not; and
the self-refresh shift instructing circuit referring to the self-refresh resetting register, and if a set value permitting resetting of the self-refresh is not stored therein, the self-refresh shift instruction is not given.

5. A microcomputer comprising the semiconductor integrated circuit device listed in claim 1.

6. Electronic equipment comprising:
the microcomputer according to claim 5;
input means subject to processing by the microcomputer; and
LCD output means for outputting data processed by the microcomputer.

7. The semiconductor integrated circuit device including the memory controller performing access control based on the access request from the host with respect to the dynamic random access control having the self-refresh function, the memory controller comprising:
the self-refresh shift instructing circuit which performs, after detecting the idle state, processing necessary for instructing the dynamic random access memory to shift to the self-refresh state.

8. The semiconductor integrated circuit device according to claim 7, the memory controller further comprising:
the self-refresh release instructing circuit giving self-refresh release instruction necessary for instructing the dynamic random access memory to release the self-refresh state, upon receiving the access request from the host; and
an access request circuit generating and outputting an access request signal, after instructing to release the self-refresh.

9. The semiconductor integrated circuit device according to claim 7, the memory controller further comprising:
a self-refresh resetting register capable of setting a selected value as to whether to reset the self-refresh or not; and
the self-refresh shift instructing circuit referring to the self-refresh resetting register, and if a set value permitting resetting of the self-refresh is not stored therein, the self-refresh shift instruction is not given.

10. A microcomputer comprising the semiconductor integrated circuit device listed in claim 7.

11. Electronic equipment comprising:
the microcomputer according to claim 10;
input means subject to processing by the microcomputer; and
LCD output means for outputting data processed by the microcomputer.
